(19) United States
(12) Patent Application Publication
(10) Pub. No.: US 2015/0052231 A1
(43) Pub. Date: Feb. 19, 2015

(54) PROVIDING CUSTOM NAMES FOR HEADLESS DEVICES

(71) Applicant: QUALCOMM Incorporated, San Diego, CA (US)

(72) Inventors: Yanjun Sun, San Diego, CA (US); Olivier Jean Benoit, San Diego, CA (US); Brian Michael Buesker, San Diego, CA (US); Peerapol Tinnakornsrisuphap, San Diego, CA (US)

(73) Assignee: QUALCOMM Incorporated, San Diego, CA (US)

(21) Appl. No.: 13/970,298

(22) Filed: Aug. 19, 2013

(51) Int. Cl. H04L 12/24; H04L 29/12

(52) U.S. Cl. CPC H04L 41/0803; H04L 41/12; H04L 61/103
USPC 709/223

(57) ABSTRACT

A headless device does not have a user interface that conveniently allows the user to enter a custom name for the headless device. In this disclosure, a custom name may be determined (either automatically or via user input) at a user device, such as a user device that has a user interface. The custom name may be based on the type of device, location, services, and/or other information about the headless device. The custom name is introduced to the communications network in association with a network address of the headless device. In some embodiments, forged messages based on conventional network protocols may be used to associate the custom name with the network address of the headless device.

### BACKGROUND

Embodiments of the inventive subject matter generally relate to the field of communications systems, and, more particularly, to providing a custom name associated with a headless device in a communication network.

Some devices that are expected to be used in a communications network (such as a home communications network) may be considered a “headless” device. A headless device has limited or no user interface. Examples of headless devices might include sensors, light bulbs, cameras, actuators, appliances, game controllers, audio equipment or other devices that may be capable of communicating via the home network but which may not have a graphical user interface due to commercial or technical limitations. In addition to headless devices, some devices are hard to reach (e.g., light bulb, motion sensors, etc., such as devices that may be utilized on a ceiling). These devices may be considered “unreachable” devices due to their physical placement. Headless or unreachable devices may be difficult for a user to configure.

In some communications networks, users may have limited technical capability or infrastructure to support advanced configurations of headless devices. For example, in a home communication network, many headless devices may be introduced. A home communication network may also be referred to as a hybrid communication network, home environment network, mixed communication network, or simply a “home network.” A home owner may manage a home communication network using less sophisticated tools and may be unable to manage the headless devices using low level network protocols.

### SUMMARY

In this disclosure, various embodiments are described for providing human-friendly naming and service discovery of headless devices. Several embodiments described may be used with conventional headless devices, and often without the need to introduce complex configuration tools, such that an administrator of a communications network may use human-friendly names to identify and manage headless devices in the communications network.

In one embodiment, a first user device of a communications network may determine that a headless device is communicatively coupled to the communications network. The first user device may determine a custom name to associate with a network address of the headless device. The first user device may send, from the first user device on behalf of the headless device, a network message identifying the headless device by the custom name such that the network message notifies other devices in the network of the custom name for the headless device.

In another embodiment, a network node of a communications network may receive a configuration message from a first user device communicatively coupled to the communications network, the configuration message including a custom name to be associated with a headless device. The network node may receive, from the headless device, a request for a network address. The network node may modify the request for the network address to include the custom name, and forward the modified request to a network address assignment server.

In another embodiment, a first user device communicatively coupled to a communications network may discover a headless device communicatively coupled to the communications network. The first user device may determine an application service type provided by the headless device, and determine a location of the headless device. The first user device may assign a custom name for the headless device based, at least in part, on the application service type and the location.

### BRIEF DESCRIPTION OF THE DRAWINGS

The present embodiments may be better understood, and numerous objects, features, and advantages made apparent to those skilled in the art by referencing the accompanying drawings.

FIG. 1 is a system diagram illustrating an example implementation of associating a custom name with a headless device in accordance with an embodiment of this disclosure.

FIG. 2 is a flow diagram of example operations that may be performed to associate a custom name with a headless device in accordance with an embodiment of this disclosure.

FIG. 3 is an example system diagram illustrating the use of multicast DNS protocol messages to associate a custom name with a headless device in accordance with an embodiment of this disclosure.

FIG. 4 is an example system diagram illustrating the use of a network node delegated to associate a custom name with a headless device in accordance with an embodiment of this disclosure.

FIG. 5 is an example system diagram illustrating the use of DHCP protocol messages to associate a custom name with a headless device in accordance with an embodiment of this disclosure.

FIG. 6 is an example block diagram of various protocol stacks operable to implement various embodiments in this disclosure.

FIG. 7 is an example flow diagram showing operations that may be used to detect a new headless device in the communications network using sensor/detector components of a first user device in accordance with this disclosure.

FIG. 8 is an example flow diagram showing operations that may be used to detect new headless devices in the communications network using network discovery protocol messages in accordance with this disclosure.

FIG. 9 is an example flow diagram showing operations that may be used to assign a custom name for a headless device in accordance with this disclosure.

FIG. 10 is a conceptual diagram illustrating a user interface of a first user device operable to implement various embodiments of this disclosure.

FIG. 11 is an example block diagram illustrating a first user device capable of assigning a custom name to a headless device in accordance with various embodiments of this disclosure.

### DESCRIPTION OF EMBODIMENT(S)

The description that follows includes exemplary systems, methods, techniques, instruction sequences and computer program products that embody techniques of the present inventive subject matter. However, it is understood that the described embodiments may be practiced without these specific details. For instance, although examples refer to headless devices, the embodiments described herein may apply to unreachable devices, damaged devices or other devices in which a user interface is not readily accessible. Furthermore, although examples may refer to types of protocols, such as domain name service (DNS), multicast DNS (mDNS), or DNS Service Discovery (DNS-SD), it should be understood that other protocols providing similar functionality may be substituted without limitation to the scope of the disclosure. In other instances, well-known instruction instances, protocols, structures and techniques have not been shown in detail in order not to obfuscate the description.

In this disclosure, example headless devices (e.g., smart lighting systems, smart thermostats, etc.) are typically manufactured for use with a home communication network (e.g., a home WLAN, a powerline network, etc.). As more headless devices are introduced to the home communication network, it becomes difficult for an administrator to identify the location and/or purpose of each headless device. For example, consider a home communications network having tens or hundreds of embedded and networked devices such as various smart sensors, smart appliances, and surveillance systems. Lack of a user interface in headless devices may make it hard to configure a location or name directly into the headless devices via a user interface. As such, it may be difficult for a user to easily name and discover a headless device in a human friendly way. Meanwhile human-friendly names may be useful for some consumer devices.

Some headless devices come with a tag, label, or other information which identifies a manufacturer-assigned media access control (MAC) address. Alternatively, the headless device may come with a manufacturer-assigned device name or device identifier. However, it may be difficult for the user to identify the devices by the MAC addresses or device ID, especially when the number of devices becomes large. Furthermore, an IP address may be used to communicate with the device. IP addresses may be traditionally discovered using a manual process, a DNS server, or a specific configuration application provided by the manufacturer for each device.

In accordance with this disclosure, several embodiments are described to enable the user to easily name and discover headless devices in a communications network (such as a home network) in a human friendly way. For example, a user device may be used to assign a custom name to a headless device. The custom name may be based on the type of device, location, or other information. In some implementations, the user may assign user-friendly names to headless device without requiring modification to the headless device and without requiring a dedicated DNS server in the communications network. In addition to naming headless devices, service discovery may be improved by using contextual names for services provided by each headless device. Although described as different embodiments, several of the techniques described herein may be combined for various implementations.

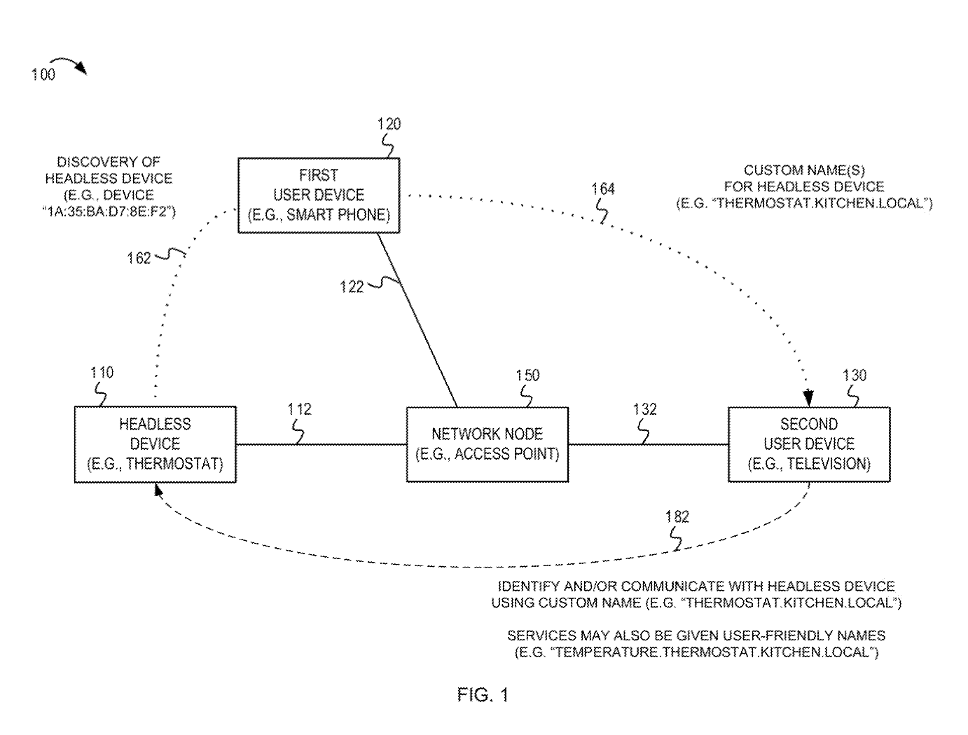

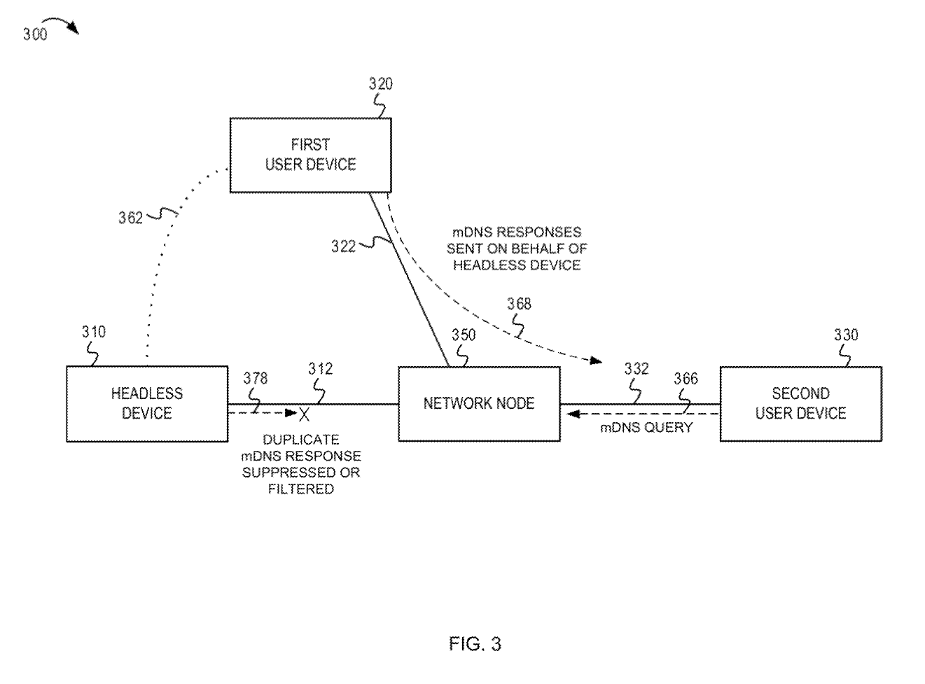

FIG. 1 is used to introduce several concepts that may be relevant to multiple embodiments described herein. FIG. 1 is a system diagram 100 in which a headless device 110, a first user device 120, a second user device 130, and a network node 150 are communicatively coupled via a communications network. It should be understood that the types of equipment in FIG. 1 are non-limiting examples. For example, the headless device may be any type of device for which a user does not readily have a user interface to configure a custom name. Examples of headless device may include a smart light bulb, smart refrigerator, stereo system, sound system, thermostat, security system component, light sensor, motion detector, etc. To aid in the understanding of custom names, an example system is described. By way of example, the headless device 110 in FIG. 1 may be a network enabled thermostat. The headless device 110 may have a unique MAC address and be communicatively coupled (shown as line 112) to the communications network. The communication network may include one or more network nodes, such as network node 150. By way of example, the network node 150 may be a wireless access point. A first user device 120 (e.g., smartphone) is communicatively coupled (shown as line 122) to the communications network. A second user device 130 (e.g., network-enabled television) is communicatively coupled (shown as line 132) to the communications network. It should be understood that each of the communications links 112, 122, 132 may be wireless links or wired links. For example, the headless device 110 and first user device 120 may use a wireless access point to couple with the communications network, while the second user device 130 may use a wired connection (e.g., powerline communications, Ethernet, multimedia over coax, or other technology) to couple to the communications network. It is noted that the architecture of FIG. 1 is similar to the architectures in FIGS. 3-5, which describe various embodiments.

Returning to FIG. 1, the headless device 110 may be coupled to the communications network. Upon coupling the headless device 110 to the communications network, the first and second user devices 120, 130 may attempt to discover and/or configure the headless device 110. However, the headless device 110 may be pre-configured with a default identifier, name, MAC address, or other indicia which is not relevant to the environment in which it is placed. For example, the thermostat may be preconfigured with a MAC address “1A:35:BA:D7:8E:F2” but without a logical name. Alternatively the thermostat may be configured with a default logical name that is confusing to an administrator of the communications network—especially if more than one thermostat is in the communications network. As an example, a user interface (e.g., display screen of the television) on the second user device 130 may indicate the preconfigured address or default name.

In accordance with this disclosure, one of the user devices 120, 130 may be capable of introducing a custom name for the headless device 110. In some embodiments, the user device may use already-implemented network protocols to introduce the custom name. FIGS. 3-5 describe several examples of modifying implemented network protocols to introduce the custom name. For purposes of this disclosure, the first user device 120 will introduce the custom name. However, it should be understood that any type of user device may be capable of performing operations described herein in relation to first user device 120. In some embodiments, the first user device 120 may be capable of introducing the custom name for the headless device 110 such that the network node 150 and second user device 130 may also utilize the custom name without requiring modifications to existing protocols implemented at the network node 150 and second user device 130. In other embodiments, the first user device 120 may coordinate with the network node 150 to introduce the custom name for the headless device 110 such that the second user device 130 may also utilize the custom name without requiring modifications to existing protocols implemented at the second user device 130.

Having described the architecture of FIG. 1, an example embodiment will now be described.

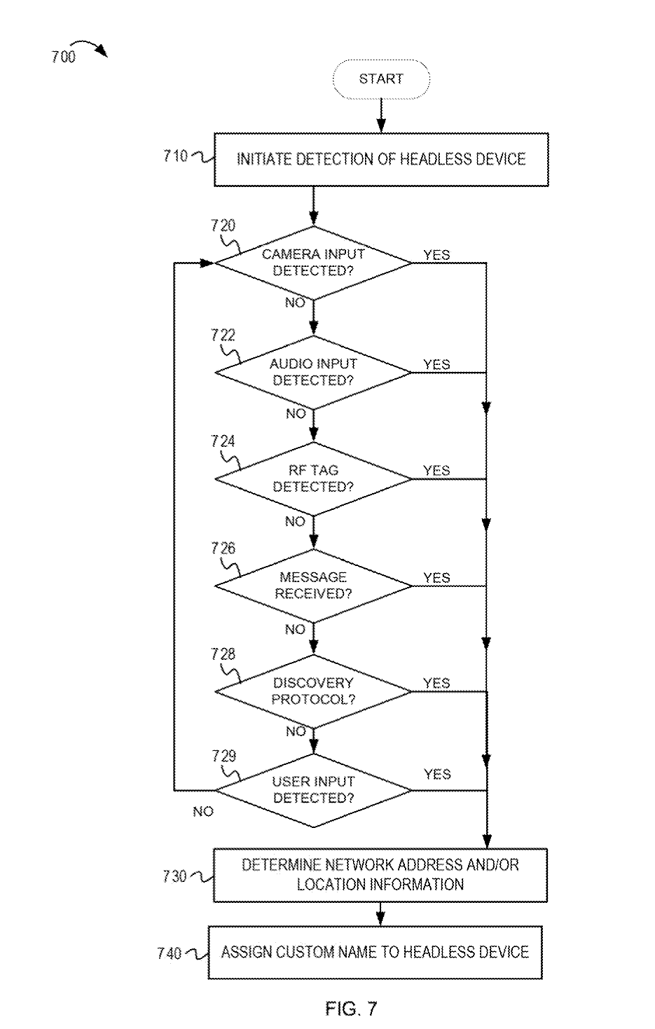

At 162, the first user device 120 may discover the headless device 110. For example, the first user device 120 may detect broadcast messages via the communications network. Alternatively, a service discovery protocol may be used by the first user device 120 to detect the presence of the headless device 110. In another alternative, the first user device 120 may become aware of the new headless device by receiving information about the headless device 110 via a user input component, detector, sensor, or other component of the first user device 120. For example, the first user device 120 may have a camera capable of scanning a barcode (e.g., a UPC barcode or Quick Response QR code image) or other image of the headless device 110. Various ways of detecting the headless device 110 are further described below in FIG. 7. In addition to detecting the presence of the headless device 110, the first user device 120 may obtain additional information about the headless device 110. For example, the first user device 120 may obtain the network address, application services, device type, or other information about the headless device 110. The first user device 120 may also determine or estimate the location of the headless device 110 within the communications network. For example, the first user device 120 may discover that the thermostat (headless device 110) is located in a kitchen of a home network.

At 164, the first user device 120 may assign a custom name to the headless device 110 and utilize various protocol messages to introduce the custom name to other devices coupled to the communications network. In some embodiments, the first user device 120 may automatically assign the custom name from among a plurality of pre-defined human-friendly names. Alternatively, the first user device 120 may receive user input either confirming or changing the custom name for the headless device 110. In the example of a thermostat located in the kitchen, the first user device 120 may assign “thermostatkitchen.local” as a custom name for the thermostat installed in the kitchen. Once the custom name has been determined (either automatically or by user input), the custom name is provided to other devices in the communications network in such a way that the other devices may also utilize the custom name. This disclosure provides several techniques which may be used to introduce the custom name to the communications network. For example, protocol messages associated with an already-implemented network protocol (such as, without limitation, multicast DNS, service discovery, dynamic host configuration protocol (DHCP), etc.) may be used to introduce the custom name to other devices in the communications network. The second user device 130 may discover the custom name using the already-implemented network protocol.

This disclosure provides at least three techniques which can be used to provide the custom name of the headless device 110 for use by the communications network. In one technique, the first user device 120 may send, on behalf of the headless device 110, name translation or service discovery responses identifying the headless device 110 by the custom name. For example, the first user device 120 may intentionally inject fake multicast DNS messages from the first user device 120, wherein the fake multicast DNS messages identify the network address of the headless device 110 and the assigned custom name. Alternatively, the first user device 120 may send a delegation instruction to a network node 150 (or another user device) to cause the network node 150 to respond to the name translation or service discovery messages on behalf of the headless device 110. In another alternative, the first user device 120 may communicate the custom name to the network node 150 so that the network node 150 can modify DHCP messages from the headless device 110 to include the custom name. These and other various techniques are described in more detail in the following Figures.

At 182, the second user device 130 has become aware of the custom name and may use the custom name to identify and/or communicate with the headless device 110. For example, the television may display “thermostat.kitchen.local” on the display screen. A user that selects the thermostat may initiate a communication from the television to the thermostat using the custom name. It should be noted that services provided by the headless device 110 may also be given custom (e.g., human-friendly) names. In an example of FIG. 1, the first user device 120 may discover a service associated with providing temperature data. The first user device 120 may assign a custom name of “temperature.thermostat.kitchen.local” for the service on the headless device 110 that provides temperature data.

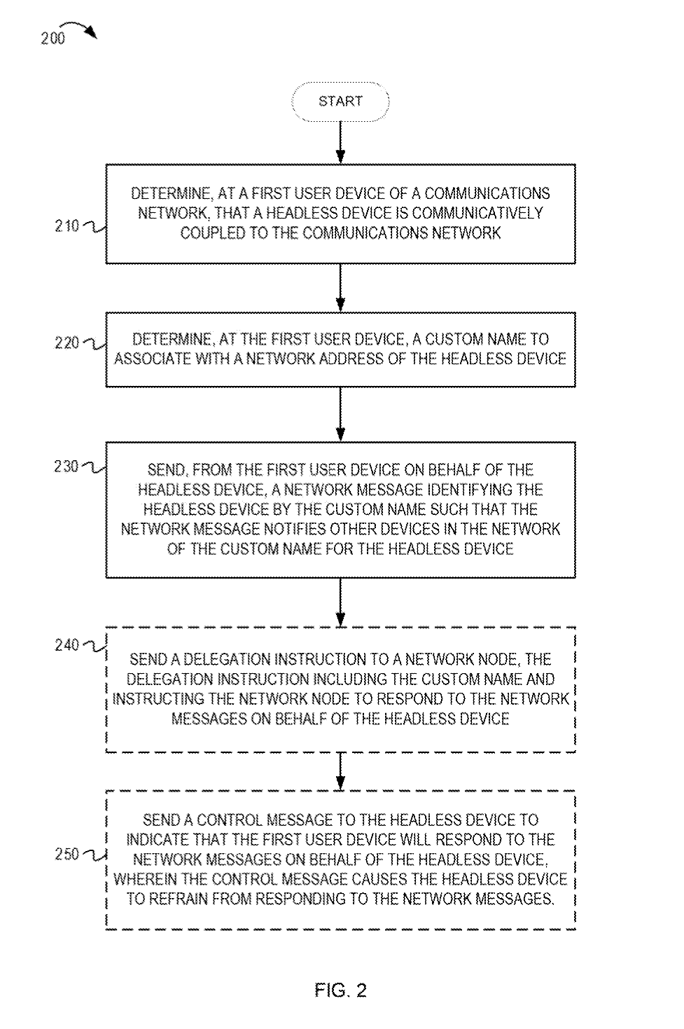

FIG. 2 is a flow diagram 200 of example operations that may be performed to associate a custom name with a headless device in accordance with an embodiment of this disclosure. At block 210, a first user device of a communications network determines that a headless device is communicatively coupled to the communications network. At block 220, the first user device determines a custom name to associate with a network address of the headless device.

Once the custom name has been determined, the custom name may be included in name translation or service discovery messages. However, in some communications networks, the headless device may be unaware of the custom name or be unable to utilize the custom name. FIG. 2 describes two ways in which the custom name may be introduced in the network without the use of the headless device.

At block 230, the first user device may send, from the first user device on behalf of the headless device, a network message identifying the headless device by the custom name such that the network message notifies other devices in the network of the custom name for the headless device. For example, the first user device may send name translation or service discovery responses identifying the headless device by the custom name. At optional block 240, the first user device may send a delegation instruction to a network node. The delegation instruction may include the custom name and instruct the network node to respond to the network messages on behalf of the headless device.

At optional block 250, the first user device (or the network node) may send a control message to the headless device to indicate that the first user device (or the network node) will respond to the network messages (e.g., name translation or service discovery requests) on behalf of the headless device. The control message may cause the headless device to refrain from responding to the network messages. In some communications networks, the network node may also filter name translation or service discovery requests directed to the headless device when the network node is aware that either the first user device or the network node will respond to the name translation or service discovery requests on behalf of the headless device. Suppressing name translation or service discovery requests to the headless device (or causing the headless device to refrain from responding to the name translation or service discovery requests) may reduce power consumption at the headless device. This may be useful in extending operational periods of the headless device, particularly for headless devices that operate on battery power.

FIG. 3 is an example system diagram illustrating the use of multicast DNS protocol messages to associate a custom name with a headless device in accordance with an embodiment of this disclosure. FIG. 3 includes a headless device 310, first user device 320, second user device 330, and network node 350, which are similar to corresponding features described in relation to FIG. 1. The headless device 310 is communicatively coupled (shown as line 312) to network node 350. The first user device 320 is communicatively coupled (shown as line 322) to network node 350. The second user device 330 is communicatively coupled (shown as line 332) to network node 350.

In FIG. 3, the first user device 320 or network node 350 may serve as a delegate (or proxy) for the headless device 310 in order to introduce a custom name for the headless device 310. For example, the first user device 320 may intentionally inject (i.e., transmit) multicast DNS (mDNS) messages that are constructed to advertise the network address and the custom name of the headless device 310. Multicast DNS may be supported by many devices on the market already through protocols such as ZeroConf™, Bonjour™, or AllJoyn™.

At 362 (similar to 162), the first user device 320 may discover the headless device 310. The first user device 320 may create and/or assign a custom name for the headless device 310. In FIG. 3, the first user device 320 may respond to address translation or service discovery messages on behalf of the headless device 310 using a multicast DNS protocol. In addition, the first user device 320 may discover services available on the headless device 310 and announce them using the custom name created for the headless device 310. As an example, the first user device 320 may voluntarily take over name translation and service announcement on behalf of the headless device 310. The first user device 320 may use “faked” multicast DNS messages to introduce the custom name and network address of the headless device 310.

At 366, the second user device 330 may transmit an mDNS query message. At 368, the first user device 320 may transmit an mDNS response on behalf of the headless device 310. In some embodiments, the first user device 320 may also respond to service discovery requests on behalf of the headless device 310. So when the second user device 330 (e.g., TV) initiates a service discovery, the first user device 320 may respond with the services of the headless device 310 and identify the custom name. The custom name and service may be more meaningful for the user than the alternative default name or identifier previously associated with the headless device 310.

One possible challenge for the second user device 330 is that for each service type of a headless device 310, there may be more than one entry to identify the service type of the headless device 310. For example, one entry may be associated with a factory-programmed name (e.g., “temperature.10.0.1.2”) specified by the headless device 310, and another entry may be associated with the custom name specified by the first user device 320 (e.g., “temperature.thermostat.kitchen.local”). It may be useful to remove the service associated with the factory-programmed name to prevent duplication or confusion. At 378, there may be at least three ways to filter or suppress the duplicate service announcement:

In a first alternative, the first user device 320 or network node 350 may notify the headless device 310 not to respond to service discovery messages after the first user device 320 or network node 350 takes over responding to service discovery messages on behalf of the headless device 310. For example, a control message may be sent to the headless device 310 to suppress service announcements from the headless device 310.

In a second alternative, the second user device 330 may also filter the duplicate service announcements. For example, the service discovery application (e.g., on the second user device 330) may be modified to remove the entry associated with the duplicate entry. The second user device 330 may identify the factory-programmed name or default name/identifier that has the same network address as another entry with a custom name. Once the extra factory-programmed name or default name/identifier is identified, the second user device 330 may remove the factory-programmed name or default name/identifier from a list of headless devices in the communications network.

In a third alternative, the network node 350 may be configured to filter (i.e., not forward) service discovery packets to the headless device 310 once the first user device 320 or network node 350 has assumed responsibility for responding to service discovery requests on behalf of the headless device 310.

It should be noted that although techniques in FIG. 3 are described in relation to a multicast DNS protocol with service discovery, similar techniques may be possible with other protocols used for name translation and/or service discovery.

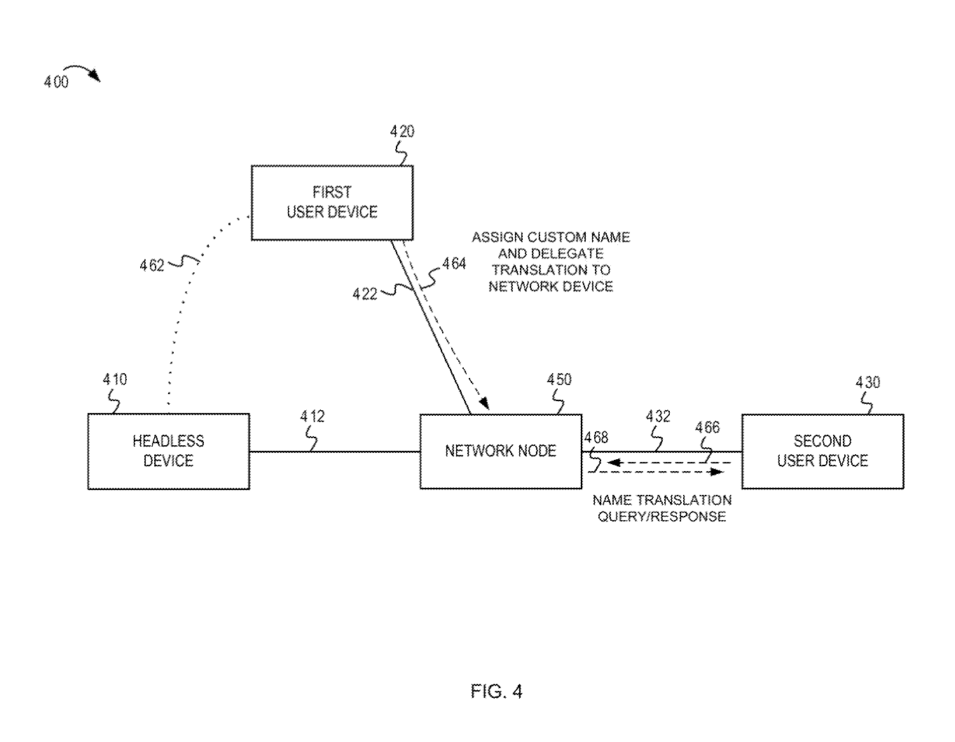

FIG. 4 is an example system diagram illustrating the use of a network node delegated to associate a custom name with a headless device in accordance with an embodiment of this disclosure. FIG. 4 includes a headless device 410, first user device 420, second user device 430, and network node 450, which are similar to corresponding features described in relation to FIG. 1. The headless device 410 is communicatively coupled (shown as line 412) to network node 450. The first user device 420 is communicatively coupled (shown as line 422) to network node 450. The second user device 430 is communicatively coupled (shown as line 432) to network node 450. At 462 (similar to 162, 362), the first user device 420 may discover the headless device 410. The first user device 420 may create and/or assign a custom name for the headless device 410.

As described in FIG. 3, the first user device 320 (e.g., smartphone) may be capable of sending name translation or service discovery messages on behalf of the headless device 310. In FIG. 4, the network node 450 may send the name translation or service discovery messages on behalf of the headless device 410. In some embodiments, the network node may send the name translation or service discovery message on behalf of the headless device when a first user device is turned off or has left the network.

At 464, the first user device 420 may determine the custom name for the headless device 410 and then delegate the name translation or service discovery proxy features to the network node 450. The network node 450 may be a more persistent device, such as an Access Point (AP) or an always-on computer. As multicast DNS messages can also be heard by the network node 450, the delegation can be done using some changes to service name translation or service discovery layer protocols at the network node 450. In some implementations, the network node 450 may also filter service discovery messages from being sent to the headless device 410. Filtering name translation or service discovery messages from being sent to the headless device 410 may not only help to reduce power consumption at the headless device 410, but may also prevent duplicated service announcements discussed above.

When the second user device 430 performs a name translation or service discovery request (shown as arrow 466), the network node 450 may respond directly (shown as arrow 468) without forwarding the name translation or service discovery request to the headless device 410.

It should be noted that some headless devices may not support multicast DNS. In some instances, other protocols (such as DHCP) may be used to associate a custom name with the headless device.

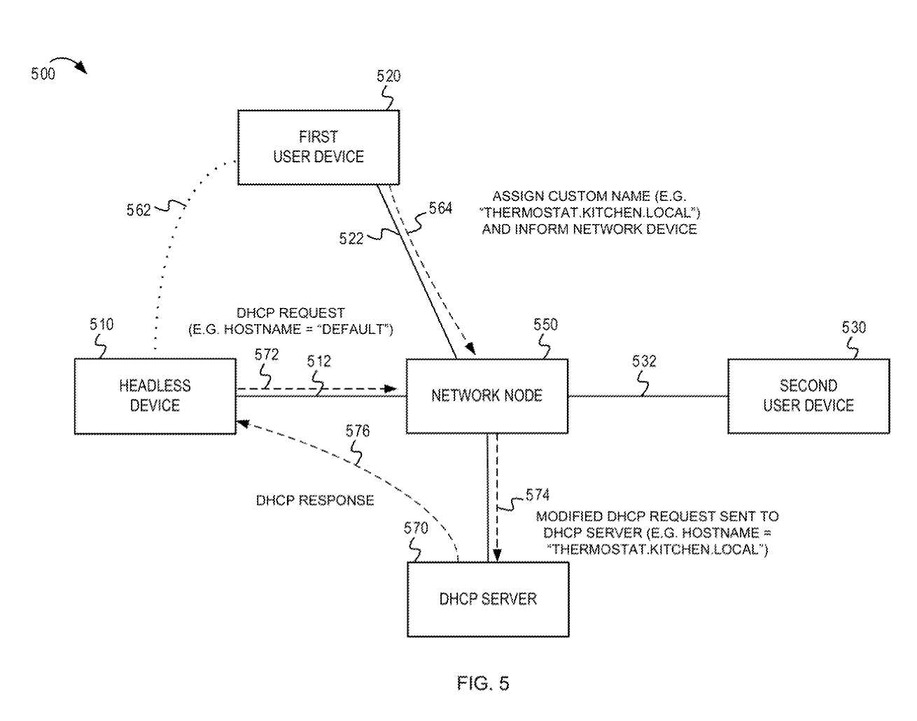

FIG. 5 is an example system diagram illustrating the use of DHCP protocol messages to associate a custom name with a headless device 510 in accordance with an embodiment of this disclosure. In FIG. 5, custom naming and name translation may be possible by intercepting and modifying DHCP messages from the headless device 510, such as when the headless device 510 uses DHCP to obtain a network address. A host name option defined in the DHCP Request message may be modified to insert the custom name.

FIG. 5 includes a headless device 510, first user device 520, second user device 530, and network node 550, which are similar to corresponding features described in relation to FIG. 1. The headless device 510 is communicatively coupled (shown as line 512) to network node 550. The first user device 520 is communicatively coupled (shown as line 522) to network node 550. The second user device 530 is communicatively coupled (shown as line 532) to network node 550. At 562 (similar to 162, 362, 462), the first user device 520 may discover the headless device 510. The first user device 520 may create and/or assign a custom name for the headless device 510.

At 564, the custom name (in association with the MAC address of the headless device 510) is provided to the network node 550. The network node 550 may store the custom name and corresponding MAC address.

At 572, the headless device 510 may send a DHCP request to a DHCP server 574 to obtain a network address. A DHCP server is an example of a network address assignment server that utilizes a DHCP protocol to assign network addresses to devices in a network. The DHCP request may indicate a default hostname or may not include a hostname field. Whenever the network node 550 receives the DHCP request message, the network node 550 may determine if the source MAC address of the DHCP request message matches the headless device MAC address stored with a corresponding custom name. If the DHCP request message is determined to be received from the headless device, then the network node 550 may modify the DHCP request message to insert the custom name. The custom name may replace a default hostname included in the DHCP request message, or it may be added if a hostname was not already included in the DHCP request message.

At 574, after the DHCP request message is modified, the modified DHCP request is forwarded to the DHCP server 574 in the network. As a result of modifying the DHCP request message, the custom name will be associated with the network address (e.g., IP address) assigned by the DHCP server 570. Other devices in the network can communicate with the headless device 510 using the custom name if the DHCP server 570 maintains a hostname-lookup table (e.g., DHCP host name option, or DNS service). In case the host name option is not supported by the DHCP server 570, the network node 550 may observe the DHCP response (576) and store the assigned network address with the corresponding custom name. Thereafter, the network node 550 or the DHCP server 570 may respond to DNS requests for the custom name. If the network node 550 or DHCP server 570 performs DNS, the DNS service can simply add a CNAME record in DNS so that lookups for either a default factory-programmed hostname or the custom name will both successfully resolve to the correct network address of the headless device 510.

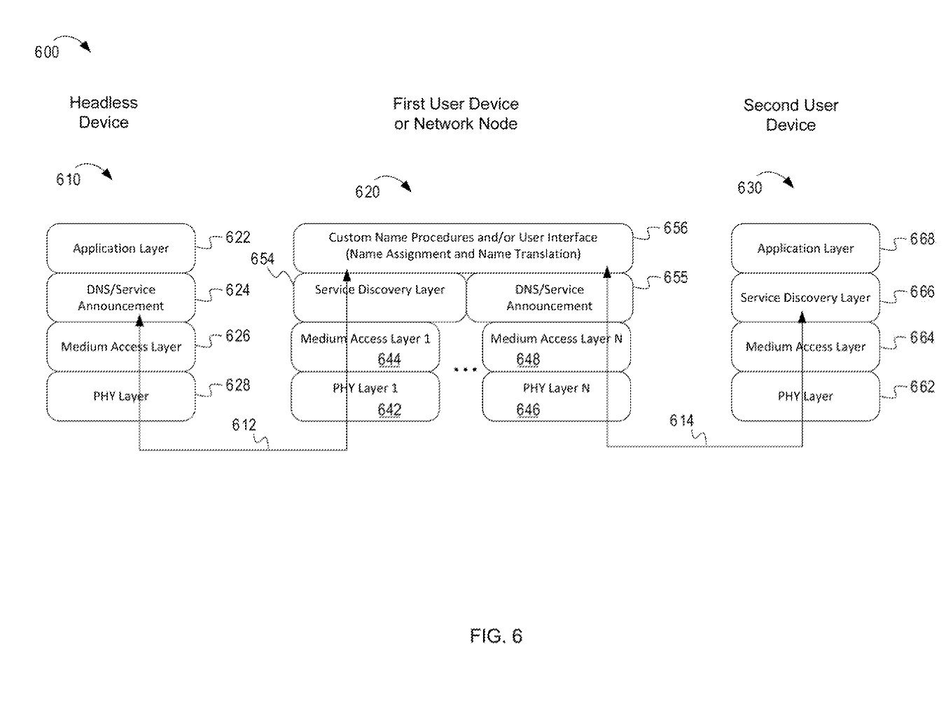

FIG. 6 is an example block diagram 600 of various protocol stacks operable to implement various embodiments in this disclosure. A protocol stack 610 may be associated with a headless device (such as headless device 110, 310, 410, 510). A protocol stack 620 may be associated with a first user device (such as first user device 120, 320, 420, 520) or a network node (such as network node 150, 350, 450, 550). A protocol stack 630 may be associated with a second user device (such as second user device 130, 330, 430, 530).

The protocol stack 610 associated with a headless device may include a PHY interface layer 628, a medium access layer 626, a multicast DNS (mDNS) and/or service announcement layer 624, and an application layer 622. In one embodiment, the mDNS/service announcement layer 624 comprises a conventional protocol without modifications. In another embodiment, the mDNS/service announcement layer 624 may be modified to receive a control message and suppress responses to name translation or service discovery messages in response to receiving the control message. The control message may be received from the first user device or the network node indicating that the first user device or the network node will respond to name translation or service discovery messages on behalf of the headless device.

A protocol stack 620 may be implemented in the first user device or network node. In some embodiments, the first user device or network node may include a plurality of physical layer interfaces 642, 646. For example, the network node may be a hybrid device with multiple physical interfaces (e.g., a wireless interface and a wired interface) capable of bridging traffic from two different communications medium. Each physical layer interface 642, 646 may be associated with a different media access layer 644, 648, respectively.

The protocol stack 620 may include a service discovery layer 654 configured to discover the headless device and services provided by the headless device. The protocol stack 620 may also include an mDNS/Service announcement layer 655 capable of communicating name translation or service discovery messages on behalf of the headless device. The protocol stack 620 may include custom name procedures and/or user interface tools 656 configured to aid in name assignment and name translation. For example, the user interface tools 656 may allow an administrator of the local area network to assign a custom name or to view a pre-selected custom name determined by the custom name procedures. The custom name procedures and/or user interface layer 656 may implement functionality described in this disclosure, such as in FIGS. 7-9 and FIG. 10.

In the example of FIG. 6, the protocol stack 630 associated with the second user device may include a Physical (PHY) interface layer 662, a medium access layer 664, a service discovery layer 666 (similar to service discovery layer 654), and an application layer 668. The service discovery layer 666 may utilize service discovery protocols to detect the headless device and may be unaware that the first user device or network node is responding to service discovery requests on behalf of the headless device.

The mDNS/service announcement layer 624, the service discovery layer 654, the mDNS/Service announcement layer 655, and the service discovery layer 666 described herein are examples of network protocol layers in the protocol stacks 610, 620, 630 capable of implementing at least one embodiment of this disclosure. Other examples may be used in various alternative embodiments. For example, a network protocol layer may utilize Internet Protocol (IP), IP version 6, named data networking (NDN), IP version 6 (IPv6), various routing protocols, neighbor discovery protocols, or the like.

FIG. 7 is an example flow diagram 700 showing operations that may be used to detect a new headless device in the communications network using sensor/detector components of a first user device in accordance with this disclosure. At block 710, the first user device may initiate detection of the headless device. For example, a user of the first user device may launch a utility application for detecting the headless device. Alternatively, the first user device may periodically automatically initiate detection of the headless device.

In some implementations, the first user device may detect encoded information that has a MAC address, identification information, or other headless device information regarding the headless device. For example, a consumer device may come with some printed instructions, labels, or packaging that provides the MAC address, identification, or other headless device information as encoded information. Once the first user device obtains the encoded information, the first user device may utilize the encoded information to determine a network address or other characteristics about the headless device using network protocol messages. Items 720-729 are described sequentially below, however it should be understood that the order may be rearranged or various items 720-729 may be omitted in some implementations.

At 720, the first user device may determine if a camera of the first user device detects the encoded information (such as an image of a barcode or other visual tag, or encoded information in the form of blinking light). If the camera detects the encoded information, the image is decoded to recover the MAC address or other identification information about the headless device from the image and the flow chart continues to block 730.

If the first user device does not detect the encoded information via the camera, then the first user device may determine if audio information is detected by a microphone at 722. For example, the microphone of the first user device may receive audio-encoded information from the headless device (such as a smart speaker). If detected, the encoded information is decoded and the flow chart continues to block 730.

If the first user device does not detect the encoded information via the audio input, then the first user device may determine if radio frequency information is detected at 724. For example, the first user device may detect a, an RFID or NFC signal, or other short range radio frequency transmission that may be used to receive the MAC address or other identification information about the headless device. If detected, the encoded information is decoded and the flow chart continues to block 730.

If the first user device does not detect the encoded information via a radio frequency signal, then the first user device may determine if a message containing the MAC address or other identification information about the headless device has been received at 726. For example, the MAC address or other identification information about the headless device may be encoded in an electronic message, short messaging service (SMS) message, or other communication received at the first user device, perhaps pursuant to a user registration of the headless device at a manufacturer or third-party registration service. If detected, the encoded information is decoded and the flow chart continues to block 730.

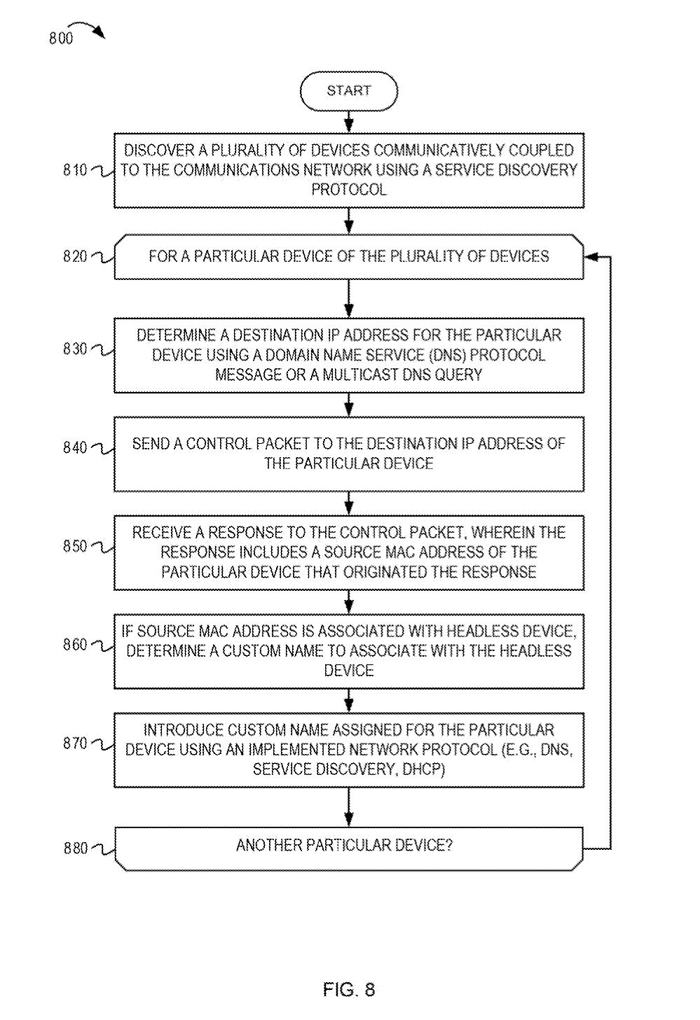

If the first user device does not detect the MAC address or other identification information about the headless device in a message received, then the first user device may attempt a discovery protocol via the communications network to obtain the MAC address or other identification information about the headless device at 728. For example, the first user device may broadcast a request message or listen for broadcast announcement messages. In some embodiments, the first user device may utilize a combination of network protocol messages to discover the headless device. FIG. 8 provides an example of a service discovery technique that may be used to ascertain the MAC address or other identification information about the headless device. If the headless device is detected, the flow chart continues to block 730.

If the first user device does not detect the MAC address or other identification information about the headless device using the discovery protocol technique, then the first user device may prompt (e.g., via a user interface) for user input of the MAC address or other identification information about the headless device at 729. If the user input is received via the user interface, the user input is used to obtain the MAC address or other identification information about the headless device and the flow chart continues to block 730.

At block 730, the first user device may determine a network address based upon the MAC address if the network address is not already discovered. Additionally, the first user device may determine location information regarding the headless device. The location information may identify, for example, a room of house or building.

The network address assigned to the MAC address may be determined in several ways, such as snooping messages and using a combination of ARP and IP lookups. For example, the first user device may observe network traffic and decode a packet having the IP address and MAC address associated with the headless device. Alternatively, the first user device may utilize an address resolution protocol (ARP) process to determine the IP address based upon the MAC address associated with the headless device. In one embodiment, the first user device may derive an IPv6 address based on the MAC address associated with the headless device. As a non-limiting example, the first user device may derive an IPv6 address by appending the MAC address of the headless device to the end of a network prefix. In another example, the first user device may derive an IPv6 address based on the MAC address associated with the headless device according to the specification for IPv6 Stateless Address Autoconfiguration (RFC 4862).”

At block 740, the first user device may determine a custom name for the headless device and introduce the custom name in association with the network address using any of the techniques described previously.

FIG. 8 is an example flow diagram showing operations that may be used to detect new headless devices in the communications network using network discovery protocol messages in accordance with this disclosure. FIG. 8 provides a non-limiting example of determining the network address using an active search of the network.

At block 810, the first user device may discover a plurality of devices communicatively coupled to the communications network using a service discovery protocol (such as DNS-SD). For example, DNS-SD may be used to discover hostnames for a plurality of devices communicatively coupled to the communications network.

At block 820, for a particular device of the plurality of discovered devices, the flowchart may include operations 830-870. In one example, each hostname discovered in block 810 may be selected for performing the operations 830-870. Alternatively, only those hostnames that are considered not human-friendly (i.e., having a default name or linguistically random name) may be selected for further investigation.

At block 830, the first user device may determine a destination IP address for the particular device using a domain name service (DNS) protocol message or a multicast DNS query. For example, the host name may be queried (e.g., using mDNS) to determine an IP address.

At block 840, the first user device may send a control packet (such as an internet control message protocol, ICMP, ping, or the like) addressed to the IP address of the particular device.

At block 850, the first user device may receive a response to the control packet, wherein the response includes a source MAC address of the particular device that originated the response. In this manner, the first user device may have discovered a correlation between a hostname, network address (IP address), and a MAC address.

At block 860, if the source MAC address in the response packet matches a MAC address of the headless device, then the first user device may determine a custom name for the headless device. Determining the custom name may include further operations (not shown) for discovery services, location, or other information about the headless device.

At block 870, the first user device may introduce the custom name assigned for the particular device (headless device) using one or more of the techniques described herein. For example, the first user device may use an existing network protocol (e.g., mDNS, Service Discovery, or DHCP) implemented in the communications network to inject the custom name associated with the network address of the headless device. For example, the first user device may respond to name translation or service discovery messages on behalf of the headless device.

At block 880, the first user device may repeat operations 830-870 for another particular device (i.e., another hostname discovered by DNS-SD).

In at least one embodiment of this disclosure, a custom name may be based on a naming convention, such as a hierarchical naming scheme. In some embodiments, it may be useful to generate a custom name that is human-friendly by representing a location or service description in the custom name.

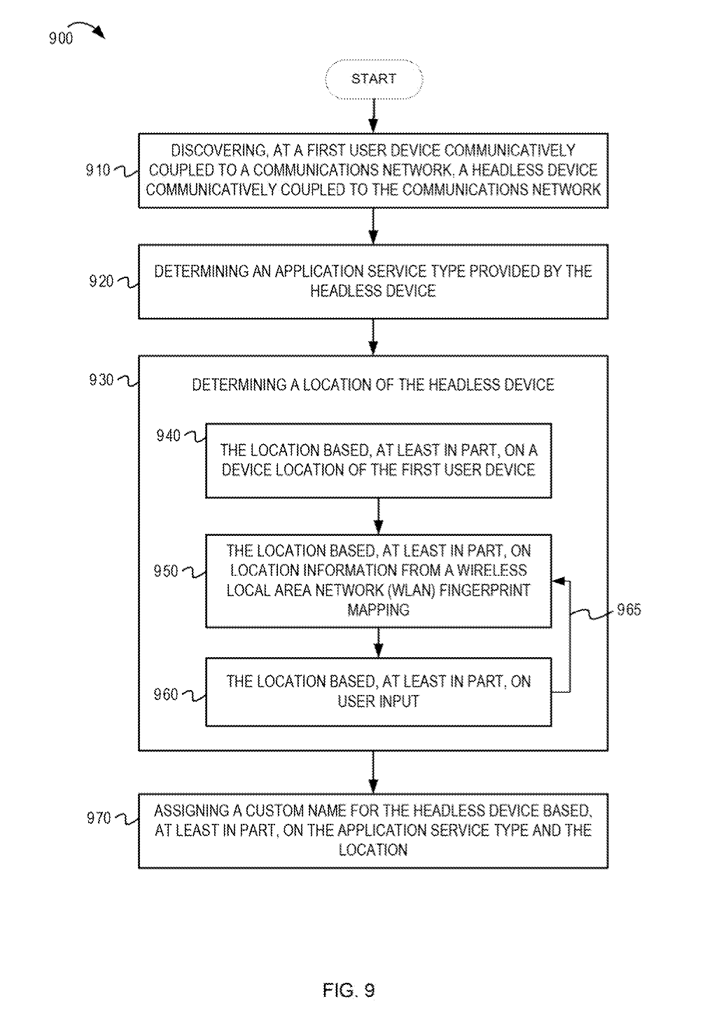

FIG. 9 is an example flow diagram 900 showing operations that may be used to assign a custom name for a headless device in accordance with this disclosure. As described previously, a first user device may be used to determine the custom name of the headless device. In some embodiments the custom name is manually generated based, at least in part, on user input (such as typing) at the first user device. However, in some implementations, it may be useful to minimize typing to speed up the process or improve user experience. In other embodiments, the custom name may be automatically generated using location information and/or service type information discovered by the first user device. In other embodiments, the custom name may be generated and provided to the user as a suggested custom name, so that a user may accept or change the suggested custom name. A custom name may be determined based, at least in part, on the service type and location of the headless device. The custom name may remind the user of what the headless does and where the device is located. FIG. 9 provides several examples in which a custom name may be determined based on location and/or service type.

At block 910, a first user device communicatively coupled to a communications network may discover a headless device also communicatively coupled to the communications network.

At block 920, the first user device may determine an application service type provided by the headless device. For example, the first user device can discover service types supported by the headless device via a service discovery protocol. Alternatively, a type of headless device may be determined based on advertised services associated with headless device. For example, an IP camera often supports the Image Capture Sharing (ICS) service. When the first user device detects that the headless device supports ICA service, the first user device may determine to include “camera” in the custom name. Other pairings of service type and custom name tags may be readily conceived by persons of skill in the art.

At block 930, the first user device may determine a location of the headless device. Blocks 940-960 describe several techniques which may be used to determine the location of the headless device. It should be noted that further techniques may be available, and that some of the techniques in blocks 940-960 may be omitted or performed in a different order than illustrated in FIG. 9.

At example block 940, the location may be based, at least in part, on a device location of the first user device. For example, the location may be determined from location information available on the first user device (e.g., a smartphone may be aware of its location within a house or may have GPS location information).

At example block 950, the location may be based, at least in part, on location information from a wireless local area network (WLAN) fingerprint mapping. For example, the first user device may estimate the location based on a wireless local area network (WLAN) fingerprint. The WLAN fingerprint may include WLAN signal characteristics including, but not limited to, a service set identifier (SSID), signal strength from one or more access points, location data from an access point, etc. The first user device may not initially have a mapping between location and WLAN fingerprint. However, the mapping between location and WLAN fingerprint may be built over time by storing user input in association with WLAN fingerprints.

At example block 960, the location may be based, at least in part, on user input. For example, the user device may present a dropdown list of common locations and receive a user selection of one of the common locations. The common location may include positions commonly used with the communications network. For example, in a home communication network, the common locations may include, without limitation: kitchen, living room, bathroom, bedroom1, bedroom2, garage and etc. A list of common locations associated with a dwelling, office, building, park, arena, etc., may be easily contemplated and is not included in this disclosure for brevity.

Shown as arrow 965, once a user input specifies the location tag (for example, either by clicking on of the proposed locations or typing in a new one), the first user device may create a mapping between the location tag and WLAN fingerprint for use with subsequent naming of other headless devices. As the database of WLAN fingerprint-location mappings increases, determining a location name for a new headless device may be enhanced by looking up the correlation between the current WLAN fingerprint and those in the database.

At block 970, the first user device may assign the custom name for the headless device based, at least in part, on the application service type and the location. For example, the first user device may include the location tag and service information in the suggested custom name. The location tag may be prepended or appended to the service type name, in accordance with a naming convention.

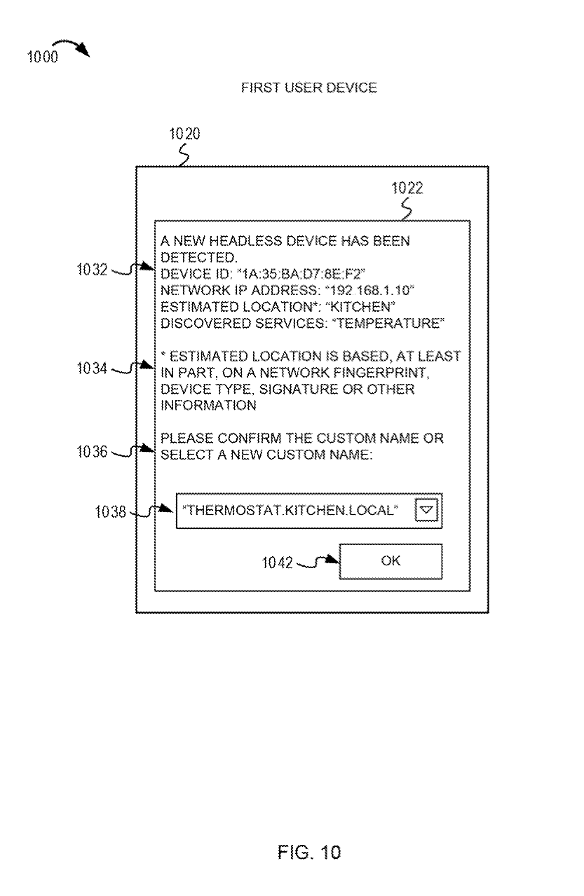

FIG. 10 is a conceptual diagram 1000 illustrating a user interface of a first user device 1020 operable to implement various embodiments of this disclosure. The first user device 1020 may be similar to first user device 120, 320, 420, 520. First user device 1020 includes a user interface 1022 (e.g., a touchscreen display). By way of example to illustrate several features of this disclosure, the user interface 1022 may display information about a new headless device that has been detected.

The user interface 1022 may display information gathered about the new headless device. In FIG. 10, at 1032 the display includes the Device ID (e.g., “1A:35:BA:D7:8E:F2” representing a manufacturer-loaded identifier or default name, such as a MAC address), and the network address (e.g., “192.168.1.10” representing an IP address on the local area network). At 1032, the display may also include information regarding the estimated location (e.g., “KITCHEN” representing a location tag as described in FIG. 9) and information about services provided by the headless device (e.g., “TEMPERATURE” representing an advertised service of a thermostat).

At 1034, the user interface 1022 may display how the location was estimated. In the example in FIG. 10, the estimated location may be based, at least in part, on a network fingerprint, device type, a signature or other information.

At 1036, the user interface 1022 may display a prompt for the user to confirm an automatically created custom name suggested by the first user device. Alternatively, the user may be allowed to select a new name from a list of potential custom names or may be permitted to type a new user-provided custom name.

In the example of FIG. 10, the user interface 1022 provides a user interface control (e.g., a dropdown control) displaying the suggested custom name (e.g., “THERMOSTAT.KITCHEN.LOCAL”) 1038 that was determined based on the device type and/or location. At 1042, the user interface 1022 includes a user interface control for easily accepting the suggested custom name.

It should be stated that the conceptual illustration 1000 of FIG. 10 is merely an example intended to aid in the understanding of a user interface for receiving user selection of approval or rejection. A variety of different user interface components (such as, without limitation, touch screen, buttons, keyboard, camera, infrared, or the like) may be used as a user interface component for receiving a user selection or entry of a custom name.

It should be understood that FIGS. 1-10 and the operations described herein are examples meant to aid in understanding embodiments and should not be used to limit embodiments or limit scope of the claims. Embodiments may perform additional operations, fewer operations, operations in parallel or in a different order, and some operations differently.

As will be appreciated by one skilled in the art, aspects of the present inventive subject matter may be embodied as a system, method, or computer program product. Accordingly, aspects of the present inventive subject matter may take the form of an entirely hardware embodiment, a software embodiment (including firmware, resident software, micro-code, etc.) or an embodiment combining software and hardware aspects that may all generally be referred to herein as a “circuit,” “module” or “system.” Furthermore, aspects of the present inventive subject matter may take the form of a computer program product embodied in one or more computer readable medium(s) having computer readable program code embodied thereon.

Any combination of one or more non-transitory computer readable medium(s) may be utilized. Non-transitory computer-readable media comprise all computer-readable media, with the sole exception being a transitory, propagating signal. The non-transitory computer readable medium may be a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program code embodied on a computer readable medium for carrying out operations for aspects of the present inventive subject matter may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present inventive subject matter are described with reference to flowchart illustrations and/or block diagrams of methods, apparatus (systems) and computer program products according to embodiments of the inventive subject matter. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

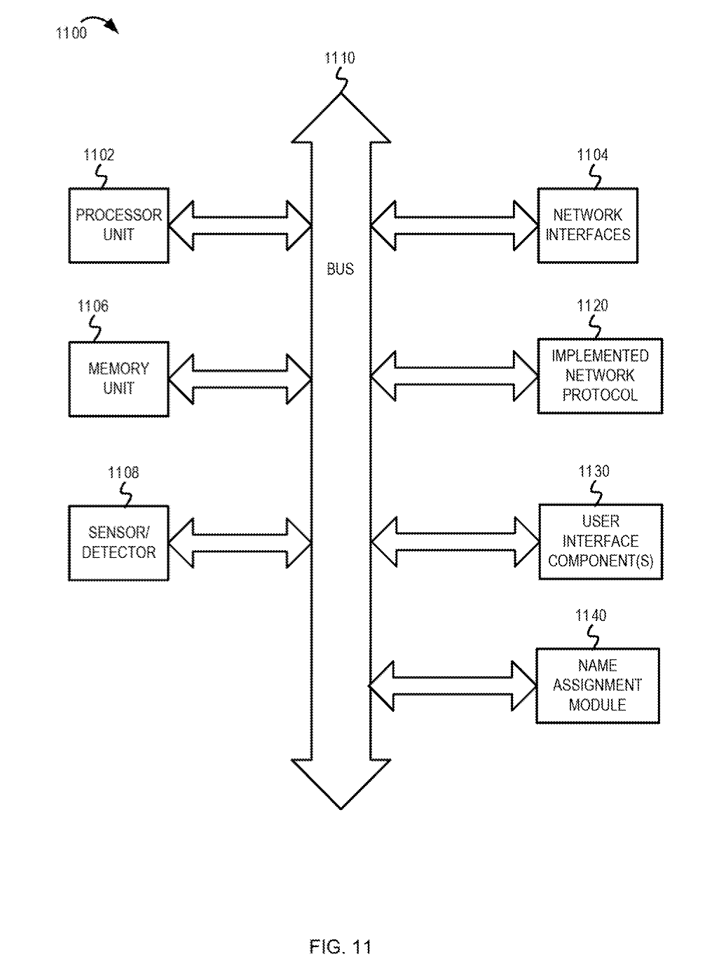

FIG. 11 is an example block diagram of one embodiment of an electronic device 1100 (e.g., first user device) capable of assigning a custom name to a headless device in accordance with various embodiments of this disclosure. In some implementations, the electronic device 1100 may be an electronic device such as a laptop computer, a tablet computer, a mobile phone, a powerline communication device, a gaming console, or other electronic systems comprising functionality to communicate across multiple communication networks (which form the hybrid communication network). The electronic device 1100 includes a processor unit 1102 (possibly including multiple processors, multiple cores, multiple nodes, and/or implementing multi-threading, etc.). The electronic device 1100 includes a memory unit 1106. The memory unit 1106 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The electronic device 1100 also includes a bus 1110 (e.g., PCI, ISA, PCI-Express, HyperTransport®, InfiniBand®, NuBus, AHB, AXI, etc.), and network interfaces 1104 that include at least one of a wireless network interface (e.g., a WLAN interface, a Bluetooth® interface, a WiMAX interface, a ZigBee® interface, a Wireless USB interface, etc.) or a wired network interface (e.g., a powerline communication interface, an Ethernet interface, etc.).

The electronic device 1100 may also include a sensor or detector component 1108. The sensor/detector component 1108 may be capable of detecting optical, audio, or radio frequency signals from a headless device or associated packaging. For example, the sensor/detector component 1108 may allow the electronic device 1100 to detect the MAC address or other identification information about the headless device as described in FIG. 7. Examples of sensor/detector components include, without limitation, a camera, a microphone, a photo sensor, a radio frequency identifier tag reader, a near-field communications (NFC) tag sensor, a short range radio frequency communications component, or an electromagnetic sensor.

The electronic device 1100 may also include one or more implemented network protocols 1120 (such as mDNS, DNS-SD, DHCP, or other network protocols as described in this disclosure). A user interface component 1130 may be included and may implement capabilities for receiving user input, such as but not limited to, the features described in FIG. 10. A name assignment module 1140 may be incorporated into the electronic device 1100 and may implement capabilities for determining and/or assigning a custom name to a headless device as described herein.

Any one of these functionalities may be partially (or entirely) implemented in hardware and/or on the processor unit 1102. For example, the functionality may be implemented with an application specific integrated circuit, in logic implemented in the processor unit 1102, in a co-processor on a peripheral device or card, etc. Further, realizations may include fewer or additional components not illustrated in FIG. 11 (e.g., video cards, audio cards, additional network interfaces, peripheral devices, etc.). The processor unit 1102, the memory unit 1106, and the network interfaces 1104 are coupled to the bus 1110. Although illustrated as being coupled to the bus 1110, the memory unit 1106 may be coupled to the processor unit 1102.

While the embodiments are described with reference to various implementations and exploitations, it will be understood that these embodiments are illustrative and that the scope of the inventive subject matter is not limited to them. In general, techniques for associating a custom name with a headless device as described herein may be implemented with facilities consistent with any hardware system or hardware systems. Many variations, modifications, additions, and improvements are possible.

Plural instances may be provided for components, operations, or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A method comprising:
determining, at a first user device of a communications network, that a headless device is communicatively coupled to the communications network;
determining, at the first user device, a custom name to associate with a network address of the headless device; and
sending, from the first user device on behalf of the headless device, a network message identifying the headless device by the custom name such that the network message notifies other devices in the communications network of the custom name for the headless device.

2. The method of claim 1, wherein the network message is one of a name translation message or a service discovery response message.

3. The method of claim 1, further comprising:
discovering application services types provided by the headless device; and
responding to a service discovery request on behalf of the headless device using the network message that identifies the headless device by the custom name.

4. The method of claim 3, wherein responding to service discovery requests includes:
receiving a service discovery request directed at the headless device; and
sending, on behalf of the headless device, a response to the service discovery request.

5. The method of claim 3, further comprising:
sending a control message to the headless device to indicate that the first user device or another device will respond to service discovery requests on behalf of the headless device, wherein the control message causes the headless device to refrain from responding to the service discovery requests.

6. The method of claim 1, further comprising:
receiving a name-address query directed to the headless device; and
responding to the name-address query on behalf of the headless device with the network message that includes the network address of the headless device.

7. The method of claim 6, wherein the name-address query comprises one of a domain name service (DNS) protocol message, a multicast DNS query, or a service discovery message.

8. The method of claim 1, further comprising:
determining a media access control (MAC) address of the headless device; and
determining the network address using the MAC address of the headless device.

9. The method of claim 8, wherein determining the MAC address of the headless device is based, at least in part, on a user input at the first user device.

10. The method of claim 9, wherein determining the MAC address of the headless device includes detecting the MAC address via a sensor of the first user device.

11. The method of claim 10, wherein the sensor is at least one of a camera, a microphone, a photo sensor, a radio frequency identifier tag reader, a near-field communications (NFC) tag sensor, a short range radio frequency communications component, or an electromagnetic sensor.

12. The method of claim 10, wherein detecting the MAC address of the headless device comprises:
detecting, using a radio frequency scanning device associated with the first user device, the MAC address, or
capturing, using a camera associated with the first user device, an image having the MAC address encoded therein.

13. The method of claim 12, wherein the image is a barcode or Quick Response (QR) code image associated with the headless device.

14. The method of claim 1, further comprising:
determining the network address of the headless device, wherein the network address comprises an Internet Protocol (IP) address.

15. The method of claim 14, wherein determining the IP address includes one of:
observing network traffic and decoding a packet having the IP address and MAC address associated with the headless device;
utilizing an address resolution protocol (ARP) process to determine the IP address based upon the MAC address associated with the headless device; or
deriving an IPv6 address based on the MAC address associated with the headless device.

16. The method of claim 1, wherein determining the network address includes:
discovering a plurality of devices communicatively coupled to the communications network using a service discovery protocol; and
for at least one device of the plurality of devices:
determine a destination IP address for the device using a domain name service (DNS) protocol message or a multicast DNS query,
send a control packet to the destination IP address of the device,
receive a response to the control packet, wherein the response includes a source MAC address of the device that originated the response, and
determine the destination IP address of the device is the network address of the headless device if the source MAC address matches a MAC address of the headless device.

17. The method of claim 1, wherein the custom name is determined using a location of the headless device.

18. The method of claim 1, wherein the custom name is determined using an application service type associated with the headless device.

19. The method of claim 1, wherein determining the custom name includes receiving the custom name from the first user device.

20. The method of claim 1, further comprising sending a delegation instruction to a network node, the delegation instruction including the custom name and instructing the network node to respond to messages directed to the headless device.

21. The method of claim 20, further comprising:
filtering name translation or service discovery messages that would otherwise be forwarded to the headless device at the network node.

22. The method of claim 20, wherein the network node comprises an access point.

23. The method of claim 1, wherein the first user device comprises a user device having a user interface.

24. A method comprising:
receiving, at a network node of a communications network, a configuration message from a first user device communicatively coupled to the communications network, the configuration message including a custom name to be associated with a headless device;
receiving, from the headless device, a request for a network address;
modifying the request for the network address to include the custom name; and
forwarding the modified request to a network address assignment server.

25. The method of claim 24, wherein the request for the network address comprises a dynamic host configuration protocol (DHCP) message.

26. The method of claim 25, wherein the network address assignment server is collocated with the network node.

27. The method of claim 24, further comprising:
updating a domain name service (DNS) of the network node to include the network address and the custom name; and
responding to a DNS query to provide the network address in response to the DNS query for the custom name.

28. A method, comprising:
discovering, at a first user device communicatively coupled to a communications network, a headless device communicatively coupled to the communications network;
determining an application service type provided by the headless device;
determining a location of the headless device; and
assigning a custom name for the headless device based, at least in part, on the application service type and the location.

29. The method of claim 28, wherein determining the location of the headless device includes at least one of:
determining the location based, at least in part, on a device location of the first user device;
determining the location based, at least in part, on location information from a wireless local area network (WLAN) fingerprint mapping; or
determining the location based, at least in part, on a user input.

30. The method of claim 29, wherein the user input comprises a dropdown list of common locations associated with a home communications network.

31. The method of claim 28, further comprising:
adding the location of the headless device to the WLAN fingerprint mapping in association with WLAN wireless signal characteristics.

32. A first user device comprising:
a network interface coupled to a communications network; and
a name assignment module configured to:
determine that a headless device is communicatively coupled to the communications network,
determine a custom name to associate with a network address of the headless device, and
send, on behalf of the headless device, a network message identifying the headless device by the custom name such that the network message notifies other devices in the communications network of the custom name for the headless device.

33. The first user device of claim 32, wherein the name assignment module is further configured to:
discover application services types provided by the headless device, and
respond to service discovery requests on behalf of the headless device using the network message that identifies the headless device by the custom name.

34. The first user device of claim 32, wherein the name assignment module is further configured to:
send a control message to the headless device to indicate that the first user device or another device will respond to service discovery requests on behalf of the headless device, wherein the control message causes the headless device to refrain from responding to the service discovery requests.

35. The first user device of claim 32, further comprising:
a network protocol layer of the first user device, the network protocol layer capable of communicating via the network interface and configured to:
receiving a name-address query directed to the headless device; and
responding to the name-address query on behalf of the headless device with a network message that includes the network address of the headless device.

36. The first user device of claim 32, further comprising:
a network protocol layer of the first user device, the network protocol layer capable of communicating via the network interface and configured to:
determine a media access control (MAC) address of the headless device, and
determine the network address using the MAC address of the headless device.

37. The first user device of claim 36, further comprising:
a sensor/detector component configured to detect the MAC address of the first user device, wherein the network protocol layer determines the MAC address in coordination with the sensor/detector component.

38. The first user device of claim 37, wherein the sensor/detector component is one or more of a camera, a microphone, a photo sensor, a radio frequency identifier tag reader, a near-field communications (NFC) tag sensor, a short range radio frequency communications component, or an electromagnetic sensor.

39. The first user device of claim 32, further comprising:
a network protocol layer of the first user device, the network protocol layer capable of communicating via the network interface and configured to:
determine the network address of the headless device, wherein the network address comprises an Internet Protocol (IP) address.

40. The first user device of claim 39, wherein the network protocol layer configured to determine the network address includes the network protocol layer being configured to:
observe network traffic and decode a packet having the IP address and MAC address associated with the headless device;
utilize an address resolution protocol (ARP) process to determine the IP address based upon the MAC address associated with the headless device; or
derive an IPv6 address based on the MAC address associated with the headless device.

41. The first user device of claim 39, wherein the network protocol layer configured to determine the network address includes the network protocol layer being configured to:
discover a plurality of devices communicatively coupled to the communications network using a service discovery protocol; and
for at least one device of the plurality of devices:
determine a destination IP address for the device using a domain name service (DNS) protocol message or a multicast DNS query,
send a control packet to the destination IP address of the device,
receive a response to the control packet, wherein the response includes a source MAC address of the device that originated the response, and
determine the destination IP address of the device is the network address of the headless device if the source MAC address matches a MAC address of the headless device.

42. The first user device of claim 32, wherein the custom name is based, at least in part, on a location of the headless device.

43. The first user device of claim 32, wherein the custom name is based, at least in part, on an application service type associated with the headless device.

44. The first user device of claim 32, wherein the name assignment module is further configured to send a delegation instruction to a network node, the delegation instruction including the custom name and instructing the network node to respond messages directed to the headless device.

45. The first user device of claim 32, wherein the name assignment module is further configured to send a control message to the headless device to indicate that the first user device or another device will respond to name translation or service discovery messages on behalf of the headless device, wherein the control message causes the headless device to refrain from responding to the name translation or service discovery messages.

46. A network node comprising:
a network interface coupled to a communications network; and
a network protocol layer configured to:
receive a configuration message from a first user device communicatively coupled to the communications network, the configuration message including a custom name to be associated with a headless device;
receive, from the headless device, a request for a network address;
modify the request for the network address to include the custom name; and
forward the modified request to a network address assignment server.

47. The network node of claim 46, wherein the request for the network address comprises a dynamic host configuration protocol (DHCP) message.

48. A non-transitory computer readable medium storing instructions which, when executed by one or more processors of a device, cause the device to perform operations comprising:
determining, at a first user device of a communications network, that a headless device is communicatively coupled to the communications network;
determining, at the first user device, a custom name to associate with a network address of the headless device; and
sending, on behalf of the headless device, name translation or service discovery responses identifying the headless device by the custom name.

49. An apparatus, comprising:
means for determining that a headless device is communicatively coupled to a communications network;
means for determining a custom name to associate with a network address of the headless device; and
means for sending, on behalf of the headless device, name translation or service discovery responses identifying the headless device by the custom name.
